(19) United States
(12) Patent Application Publication
(10) Pub. No.: US 2024/0334976 A1
(43) Pub. Date: Oct. 10, 2024

(54) An Aerosol Generating Article Comprising a Susceptor

(71) Applicant: JT International SA, Geneva (CH)

(72) Inventor: Alec Wright, Guildford (GB)

(73) Assignee: JT International SA, Geneva (CH)

(21) Appl. No.: 18/572,582

(22) PCT Filed: Jun. 21, 2022
(86) PCT No.: PCT/EP2022/066845

§ 371 Date: Dec. 20, 2023

(30) Foreign Application Priority Data
Jun. 24, 2021 (EP) 21181460.3

(51) Int. Cl. A24F 40/465; A24F 40/10; A24F 40/42; H05B 6/10

(52) U.S. Cl. CPC A24F 40/465; A24F 40/10; A24F 40/42; H05B 6/108

(57) ABSTRACT

An aerosol generating article (10, 110), for use with an aerosol generating device (30, 130) having a heating chamber (42), consists of a porous liquid storage material (12) which stores an aerosol generating liquid and which is configured for insertion into the heating chamber (42). The aerosol generating article (10, 110) also comprises an inductively heatable susceptor (16) arranged in thermal proximity to the porous liquid storage material (12) for heating and vaporising the stored aerosol generating liquid. The porous liquid storage material (12) has a substantially annular shape and defines a centrally positioned opening (14).

### TECHNICAL FIELD

The present disclosure relates generally to aerosol generating articles, and more particularly to an aerosol generating article for use with an aerosol generating device for heating the aerosol generating article to generate an aerosol for inhalation by a user. Embodiments of the present disclosure also relate to an aerosol generating system comprising an aerosol generating device and an aerosol generating article configured for use with the aerosol generating device, and to a method for using the aerosol generating system. The present disclosure is particularly applicable to an aerosol generating article for use with a portable (hand-held) aerosol generating device.

### TECHNICAL BACKGROUND

The popularity and use of reduced-risk or modified-risk devices (also known as aerosol generating devices or vapour generating devices or personal vaporizers) has grown rapidly in recent years as an alternative to the use of traditional tobacco products. Various devices and systems are available that heat or warm an aerosol generating substrate to generate a vapour which cools and condenses to form an aerosol for inhalation by a user.

Currently available aerosol generating devices can use one of a number of different approaches to heat the aerosol generating substrate, including resistive heating and induction heating. In the case of induction heating, the aerosol generating device employs an electromagnetic field generator and an induction coil to generate an alternating electromagnetic field that couples with, and inductively heats, an inductively heatable susceptor. Heat from the inductively heatable susceptor is transferred to the aerosol generating substrate to release one or more volatile components and generate a vapour.

In some conventional aerosol generating devices, the aerosol generating substrate is an aerosol generating liquid (or so called “e-liquid”), for example containing one or more of nicotine, propylene glycol, glycerine and flavourings. The aerosol generating liquid is typically stored in a liquid store of the aerosol generating device. The aerosol generating liquid is transferred from the liquid store by a liquid transfer element, such as a wick, and is heated and vaporized by heat transferred from the inductively heatable susceptor, resulting in the generation of a vapour which cools and condenses to form an inhalable aerosol. The aerosol generating liquid, liquid transfer element and inductively heatable susceptor can be provided together in a replaceable cartridge (cartomizer) that is configured for use with the vapour generating device.

Cartomizers used with conventional aerosol generating devices comprise several component parts and have a complex construction. The present disclosure seeks to address at least these drawbacks.

### SUMMARY OF THE DISCLOSURE

According to a first aspect of the present disclosure, there is provided an aerosol generating article for use with an aerosol generating device having a heating chamber, the aerosol generating article comprising:
a porous liquid storage material for storing an aerosol generating liquid and configured for insertion into the heating chamber; and
an inductively heatable susceptor arranged in thermal proximity to the porous liquid storage material for heating and vaporising the stored aerosol generating liquid;
wherein the porous liquid storage material has a substantially annular shape and defines a centrally positioned opening.

According to a second aspect of the present disclosure, there is provided an aerosol generating system comprising:
an aerosol generating device comprising a heating chamber; and
an aerosol generating article according to the first aspect positioned in the heating chamber;
the aerosol generating device further comprising an induction heating arrangement for generating an alternating electromagnetic field for penetrating the inductively heatable susceptor to thereby inductively heat the inductively heatable susceptor.

According to a third aspect of the present disclosure, there is provided a method of using an aerosol generating system according to the second aspect to generate an inhalable aerosol, the method comprising:
penetrating the inductively heatable susceptor with an alternating electromagnetic field generated by the induction heating arrangement to inductively heat the susceptor and thereby heat and vaporise the aerosol generating liquid stored in the porous liquid storage material.

The aerosol generating article is configured for use with an aerosol generating device for heating the aerosol generating liquid stored in the porous liquid storage material, without burning the aerosol generating liquid, to volatise at least one component of the aerosol generating liquid and thereby generate a heated vapour which cools and condenses to form an aerosol for inhalation by a user of the aerosol generating device. The aerosol generating device is a hand-held, portable, device.

In general terms, a vapour is a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

The aerosol generating article conveniently comprises a capsule or cartridge for insertion into the heating chamber of the aerosol generating device. The aerosol generating article is a consumable article that can be easily removed from the heating chamber when the aerosol generating liquid in the porous liquid storage material has been depleted, allowing a replacement aerosol generating article to be inserted into the heating chamber. By using an inductively heatable susceptor in combination with a substantially annular liquid storage material, efficient and rapid heating and vaporization of the aerosol generating liquid is achieved, thereby improving both the aerosol generation capabilities and the energy efficiency of the aerosol generating device. The aerosol generating article also has a simple construction that uses a small number of component parts and materials, thereby facilitating its manufacture and minimising its environmental impact. Advantageously, the aerosol generating article consists of the porous liquid storage material and the inductively heatable susceptor. Thus, the aerosol generating article does not include a liquid storage portion other than the porous liquid storage material, i.e., the aerosol generating article does not include a liquid store or a liquid reservoir for storing aerosol generating liquid. Instead, aerosol generating liquid is stored exclusively in the porous liquid storage material. The porous liquid storage material is not refillable by a user. Thus, the amount of aerosol generating liquid stored in the porous liquid storage material at the time of manufacture of the aerosol generating article determines the amount of vapour or aerosol that can be generated during use of the aerosol generating article in an aerosol generating device. By eliminating a separate liquid storage portion such as a liquid store or a liquid reservoir, the aerosol generating article has a compact size and is more easily disposable and recyclable.

The porous liquid storage material may comprise a self-supporting material. The aerosol generating article can be easily stored and handled by a user.

The porous liquid storage material may comprise a high retention material. A “high retention material” is a material that is capable of absorbing and/or storing aerosol generating liquid and that has a high retention capacity for the aerosol generating liquid. In this sense, the aerosol generating liquid is safely held or retained in the high retention material. The high retention material may be capable of storing a sufficient quantity of aerosol generating liquid for a desired period of use (e.g., a predetermined number of puffs). The high retention material may have a fibrous or spongy structure. The high retention material may include sponge-like or foam-like material. The high retention material may include any suitable material or combination of materials. Examples of suitable high retention materials are ceramic- or graphite-based materials in the form of fibres or sintered powders. In an exemplary embodiment, the high retention material may be a porous ceramic material.

The porous liquid storage material typically comprises a non-inductively heatable material, for example an electrically non-conductive and paramagnetic or diamagnetic material. Thus, the porous liquid storage material is not inductively heated in the presence of an alternating electromagnetic field.

The inductively heatable susceptor may extend circumferentially around the porous liquid storage material. The inductively heatable susceptor may extend circumferentially around a radially outer surface of the porous liquid storage material. The inductively heatable susceptor may extend circumferentially around a radially inner surface of the porous liquid storage material inside the centrally positioned opening. The inductively heatable susceptor may extend fully around the porous liquid storage material, for example around the radially outer surface or the radially inner surface. For example, the inductively heatable susceptor may fully surround the porous liquid storage material. By arranging the inductively heatable susceptor so that it extends fully around the porous liquid storage material, an efficient and uniform transfer of heat, e.g., by conduction, from the inductively heatable susceptor to the porous liquid storage material is achieved so that “hot spots” and “cold spots” are avoided. This in turn ensures that a sufficient amount of vapour or aerosol is generated during use of the aerosol generating article in an aerosol generating device.

The inductively heatable susceptor may be in thermal contact with a surface of the porous liquid storage material. For example, the inductively heatable susceptor may be in thermal contact with a radially outer surface of the porous liquid storage material or may be in thermal contact with a radially inner surface of the porous liquid storage material. This further ensures that an efficient and uniform transfer of heat, e.g., by conduction, is achieved from the inductively heatable susceptor to the porous liquid storage material.

The inductively heatable susceptor may comprise an electrically conductive material and may comprise a metal. The metal is typically selected from the group consisting of stainless steel and carbon steel. The inductively heatable susceptor could, however, comprise any suitable material including one or more, but not limited, of aluminium, iron, nickel, stainless steel, carbon steel, and alloys thereof, e.g. Nickel Chromium or Nickel Copper. With the application of an electromagnetic field in its vicinity during use of the aerosol generating article in an aerosol generating device, the inductively heatable susceptor may generate heat due to eddy currents and/or magnetic hysteresis losses resulting in a conversion of energy from electromagnetic to heat.

The induction heating arrangement of the aerosol generating device may comprise an induction coil. The induction coil may extend around the heating chamber. The induction coil may be positioned radially outwardly of the inductively heatable susceptor and may, for example, extend around an outer wall of the heating chamber. The induction coil may be positioned radially inwardly of the inductively heatable susceptor.

The induction coil may have a shape which substantially corresponds to the shape of the heating chamber. For example, the induction coil may be a helical coil.

The induction coil may comprise a Litz wire or a Litz cable. It will, however, be understood that other materials could be used.

The induction coil may be arranged to operate in use with a fluctuating electromagnetic field having a magnetic flux density of between approximately 20 mT and approximately 2.0 T at the point of highest concentration.

The aerosol generating device may include a controller with may include circuitry. The power source and circuitry may be configured to operate at a high frequency. The power source and circuitry may be configured to operate at a frequency of between approximately 80 kHz and 500 kHz, possibly between approximately 150 kHz and 250 kHz, and possibly at approximately 200 kHz. The power source and circuitry could be configured to operate at a higher frequency, for example in the MHz range, depending on the type of inductively heatable susceptor that is used.

The aerosol generating system may include a positioning arrangement to position the aerosol generating article in the heating chamber so that a longitudinal axis of the aerosol generating article is aligned with a longitudinal axis of the heating chamber. The positioning arrangement ensures that the aerosol generating article is correctly positioned in the heating chamber. By ensuring a correct positioning of the aerosol generating article in the heating chamber, an effective coupling between the generated electromagnetic field and the inductively heatable susceptor is obtained thereby ensuring that the inductively heatable susceptor is heated efficiently and rapidly by the electromagnetic field.

The positioning arrangement may comprise a projecting element, for example a locating pin, that may project into the heating chamber and that may project into the centrally positioned opening in the porous liquid storage material. The positioning arrangement thus has a simple design but nevertheless ensures the correct positioning of the aerosol generating article in the heating chamber. The induction coil may extend around the projecting element. It may be advantageous to integrate the induction coil into the projecting element in embodiments in which the inductively heatable susceptor extends around the radially inner surface of the porous liquid storage material inside the centrally positioned opening to ensure that there is an effective coupling between the generated alternating electromagnetic field and the inductively heatable susceptor.

The projecting element typically comprises a non-inductively heatable material, for example an electrically non-conductive and paramagnetic or diamagnetic material. Thus, the projecting element is not itself inductively heated in the presence of an alternating electromagnetic field.

The aerosol generating liquid may comprise polyhydric alcohols and mixtures thereof such as glycerine or propylene glycol. The aerosol generating liquid may contain nicotine. The aerosol generating liquid may contain other additives and ingredients, such as flavourants. The term “aerosol generating liquid” used herein includes any non-solid material, e.g., a semi-liquid material such as a gel or a wax, capable of generating a vapour or aerosol when heated.

### BRIEF DESCRIPTION OF THE DRAWINGS

FIG. 1 is a diagrammatic perspective view of a first example of an aerosol generating article;

FIG. 2 is a diagrammatic cross-sectional view of a first example of an aerosol generating system comprising an aerosol generating device and the first example of the aerosol generating article of FIG. 1, showing the aerosol generating article prior to being positioned in a heating chamber of the aerosol generating device;

FIG. 3 is a diagrammatic cross-sectional view of the first example of the aerosol generating system of FIG. 2, showing the first example of the aerosol generating article positioned in the heating chamber of the aerosol generating device; and

FIG. 4 is a diagrammatic cross-sectional view of a second example of an aerosol generating system comprising an aerosol generating device and a second example of an aerosol generating article positioned in a heating chamber of the aerosol generating device.

### DETAILED DESCRIPTION OF EMBODIMENTS

Embodiments of the present disclosure will now be described by way of example only and with reference to the accompanying drawings.

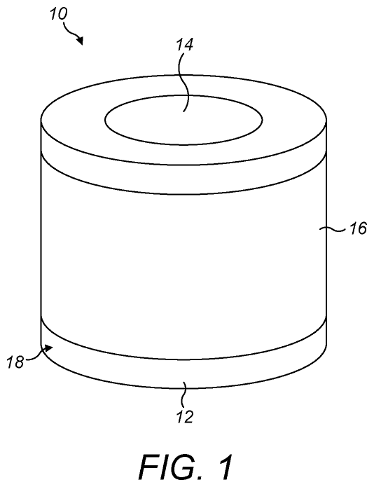

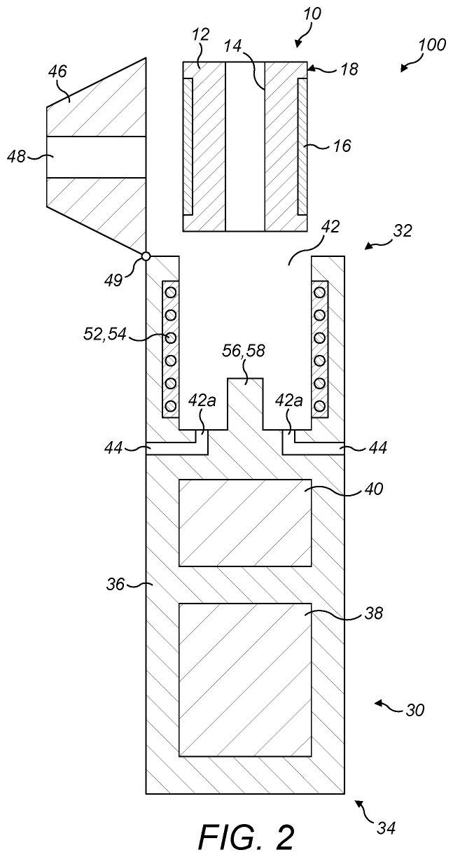

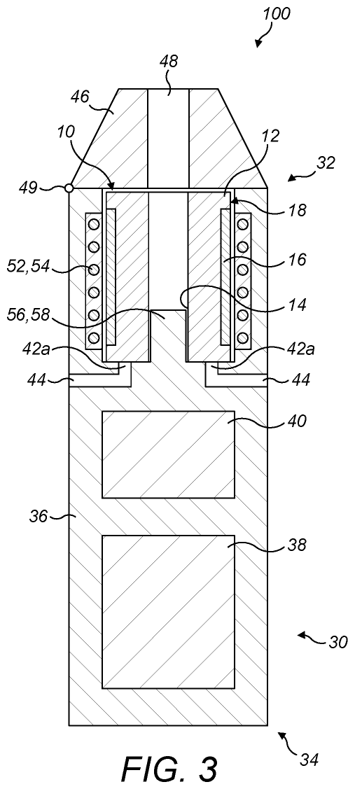

Referring initially to FIG. 1, there is shown a first example of an aerosol generating article 10 for use with an aerosol generating device 30, an example of which will be described below with reference to FIGS. 2 and 3. The aerosol generating article 10 is a consumable article, is substantially cylindrical and may be regarded as a capsule or cartridge for use with the aerosol generating device 30. The circular cross-section facilitates handling of the aerosol generating article 10 by a user and insertion of the aerosol generating article 10 into a heating chamber 42 of an aerosol generating device 30.

The aerosol generating article 10 comprises a porous liquid storage material 12 that stores or holds an aerosol generating liquid. The aerosol generating liquid may comprise an aerosol-forming substance such as propylene glycol and/or glycerol and may contain other substances such as nicotine and acids. The aerosol generating liquid may also comprise flavourings such as, e.g., tobacco, menthol or fruit flavour. The porous liquid storage material 12 typically comprises a high retention material, for example a porous ceramic, which enables the aerosol generating liquid to be readily absorbed and retained by the porous liquid storage material 12 without any leakage. The porous liquid storage material 12 is a non-inductively heatable material, meaning that it is not inductively heated in the presence of an electromagnetic field.

The porous liquid storage material 12 has a substantially annular shape and defines a centrally positioned opening 14. The centrally positioned opening 14 facilitates the positioning of the aerosol generating article 10 in a heating chamber 42 of an aerosol generating device 30, as will be explained later in this specification, and may also act as a vaporization chamber and/or vapour outlet channel.

The aerosol generating article 10 comprises an inductively heatable susceptor 16 which is arranged in thermal proximity to the porous liquid storage material 12. The inductively heatable susceptor 16 typically comprises a metal and is inductively heatable in the presence of a time varying (alternating) electromagnetic field. In the illustrated example, the inductively heatable susceptor 16 is a ring-shaped susceptor 16 which extends fully around the porous liquid storage material 12 and which is in thermal contact with a radially outer surface 18 of the porous liquid storage material 12 to allow heat to be transferred to the porous liquid storage material 12 primarily by conduction.

Referring now to FIGS. 2 and 3, there is shown a first example of an aerosol generating system 100. The aerosol generating system 100 comprises an electrically-operated aerosol generating device 30 and the first example of the aerosol generating article 10 described above. The aerosol generating device 30 has a proximal end 32 and a distal end 34 and comprises a device body 36 which includes a power source 38 and a controller 40 including circuitry which may be configured to operate at high frequency. The power source 38 typically comprises one or more batteries which could, for example, be inductively rechargeable.

The aerosol generating device 30 comprises a substantially cylindrical heating chamber 42 having one or more air inlets 42a. The heating chamber 42 is positioned at the proximal end 32 of the aerosol generating device 30 and is arranged to receive the aerosol generating article 10. The aerosol generating device 30 includes a plurality of air inlets 44 formed in the device body 36 which deliver air to the heating chamber 42 via the air inlets 42a.

The aerosol generating device 30 includes a mouthpiece portion 46 including an outlet 48. In the illustrated example, the mouthpiece portion 46 is connected to the device body 36 by a hinged connection 49, but any kind of connection may be used, such as a snap-fit connection, a bayonet connection, or a screw fitting.

The aerosol generating device 30 comprises an induction heating arrangement 52 for generating an alternating electromagnetic field that is capable of penetrating (i.e., coupling with) the inductively heatable susceptor 16 to thereby inductively heat the inductively heatable susceptor 16. The induction heating arrangement 52 comprises a substantially helical induction coil 54. The induction coil 54 has a circular cross-section and extends around the substantially cylindrical heating chamber 42. The induction coil 54 can be energised by the power source 38 and controller 40. The controller 40 includes, amongst other electronic components, an inverter which is arranged to convert a direct current from the power source 38 into an alternating high-frequency current for the induction coil 54.

As will be understood by one of ordinary skill in the art, when the aerosol generating article 10 is positioned in the heating chamber 42 as shown in FIG. 3 and the induction coil 54 is energised during use of the aerosol generating system 100, an alternating and time-varying electromagnetic field is produced. This couples with and penetrates the inductively heatable susceptor 16 and generates eddy currents and/or magnetic hysteresis losses in the susceptor 16 causing it to heat up. The heat is then transferred from the inductively heatable susceptor 16 to the porous liquid storage material 12, primarily by conduction but possibly also by radiation and/or convection. The aerosol generating liquid stored in the liquid storage material 12 is thereby heated to a temperature at which one or more volatile components are released, causing the aerosol generating liquid to be vaporised and a vapour to be generated.

The vaporisation of the aerosol generating liquid stored in the porous liquid storage material 12 is facilitated by the addition of air from the surrounding environment through the air inlets 44, 42a. The vapour generated by heating the aerosol generating liquid is released from the porous liquid storage material 12 thanks to its porosity and may cool and condense to form an aerosol. At least some of the vapour may be released into the centrally positioned opening 14 and, indeed, some vaporization of the stored aerosol generating liquid may take place in the centrally positioned opening 14. The vapour or aerosol passes through the outlet 48 in the mouthpiece portion 46 and is inhaled by a user. It will be understood that the flow of air through the aerosol generating device 30, i.e., from the air inlets 44, 42a, through the porous liquid storage material 12, and through the outlet 48 of the mouthpiece portion 46, is aided by negative pressure created by a user drawing air from the outlet side of the aerosol generating device 30 through the mouthpiece portion 46.

In order to ensure that the inductively heatable susceptor 16 is heated efficiently by the generated alternating electromagnetic field, it is important to ensure that the aerosol generating article 10 is positioned correctly with respect to the induction coil 54 so that a longitudinal axis of the aerosol generating article 10 is aligned with a longitudinal axis of the heating chamber 42. To facilitate the correct positioning of the aerosol generating article 10 in the heating chamber 42 and with respect to the induction coil 54, the aerosol generating system 100 includes a positioning arrangement 56. The positioning arrangement 56 comprises a projecting element 58, for example a locating pin or spigot, that projects into the heating chamber 42 from a distal end towards a proximal end and into the centrally positioned opening 14 in the porous liquid storage material 12 as shown in FIG. 3. The projecting element 58 comprises a non-inductively heatable material, meaning that it is not inductively heated in the presence of an electromagnetic field.

Prior to using the aerosol generating system 100, a user must first pivot the mouthpiece portion 46 to the open position shown in FIG. 2 and insert an aerosol generating article 10 into the heating chamber 42. The user can then pivot the mouthpiece portion 46 to the closed position as shown in FIG. 3 so that the aerosol generating system 100 is ready for use. The aerosol generating device 30 can then be activated (e.g., by a button press) to inductively heat the aerosol generating article 10, and more specifically the inductively heatable susceptor 16, in the manner described above to generate an inhalable aerosol. When the aerosol generating article 10 becomes depleted and no longer releases sufficient volatile components to generate an aerosol with acceptable qualities, the aerosol generating article 10 can be removed from the heating chamber 42 after pivoting the mouthpiece portion 46 to the open position, and a replacement aerosol generating article 10 can be inserted into the heating chamber 42 in its place.

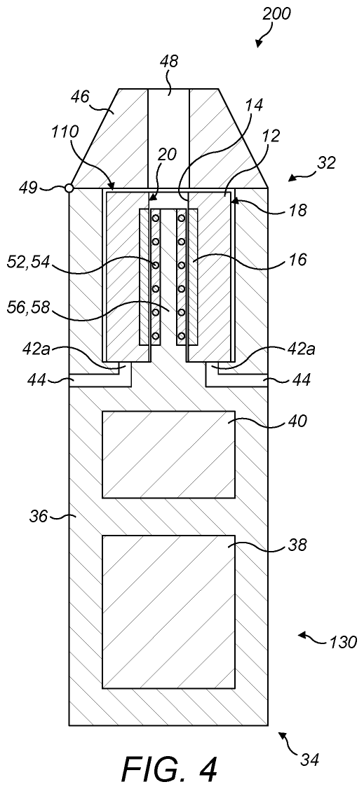

Referring now to FIG. 4, there is shown a second example of an aerosol generating system 200. The aerosol generating system 200 is similar to the aerosol generating system 100 described above with reference to FIGS. 2 and 3 and corresponding components are identified using the same reference numerals. The aerosol generating system 200 comprises an electrically-operated aerosol generating device 130 and a second example of an aerosol generating article 110.

The second example of the aerosol generating article 110 is similar to the first example of the aerosol generating article 10 described above with reference to FIGS. 1 to 3, except that the inductively heatable susceptor 16 (which is again ring-shaped and extends fully around the porous liquid storage material 12) is located in the centrally positioned opening 14 and is in thermal contact with a radially inner surface 20 of the porous liquid storage material 12 to allow heat to be transferred to the porous liquid storage material 12 primarily by conduction.

The aerosol generating device 130 is also similar to the aerosol generating device 30 described above with reference to FIGS. 2 and 3, but in this example the substantially helical induction coil 54 is provided on the projecting element 58 so that it is located, in use, adjacent to the inductively heatable susceptor 16. In this example, the projecting element 58 extends into the heating chamber 42 substantially along the full length of the centrally positioned opening 14 so that the induction coil 56 is positioned adjacent to the inductively heatable susceptor 16 over its entire length in the longitudinal direction.

The aerosol generating system 200 is used and operated in exactly the same way as the aerosol generating system 100 to generate an inhalable aerosol.

A user can continue to inhale aerosol all the time that the aerosol generating liquid is able to continue to produce a vapour, e.g., all the time that the porous liquid storage material 12 contains sufficient aerosol generating liquid to vaporise into a suitable vapour. The controller 40 can adjust the magnitude of the alternating electrical current supplied to the induction coil 54 to ensure that the temperature of the aerosol generating liquid does not exceed a threshold level which may be dependent upon the composition of the aerosol generating liquid.

To assist with this, in some examples the aerosol generating device 30, 130 includes a temperature sensor (not shown). The controller 40 is arranged to receive an indication of the temperature of the aerosol generating liquid from the temperature sensor and to use the temperature indication to control the magnitude of the alternating electrical current supplied to the induction coil 54. In one example, the controller 40 may supply a first magnitude of electrical current to the induction coil 54 for a first time period to heat the inductively heatable susceptor 16 to a first temperature. Subsequently, the controller 40 may supply a second magnitude of alternating electrical current to the induction coil 54 for a second time period to heat the inductively heatable susceptor 16 to a second temperature. The second temperature may be lower than the first temperature. Subsequently, the controller 40 may supply a third magnitude of alternating electrical current to the induction coil 54 for a third time period to heat the inductively heatable susceptor 16 to the first temperature again. This may continue until the aerosol generating liquid in the porous liquid storage material 12 is expended (i.e., all vapour which can be generated by heating the aerosol generating liquid has already been generated) or the user stops using the aerosol generating device 30, 130. In another scenario, once the first temperature has been reached, the controller 40 can reduce the magnitude of the alternating electrical current supplied to the induction coil 54 to maintain the inductively heatable susceptor 16, and hence the aerosol generating liquid, at the first temperature throughout a session.

A single inhalation by a user is generally referred to a “puff”. In some scenarios, it is desirable to emulate a cigarette smoking experience, which means that the porous liquid storage material 12 is typically capable of holding sufficient aerosol generating liquid to provide ten to fifteen puffs.

In some embodiments, the controller 40 is configured to count puffs and to interrupt the supply of electrical current to the induction coil 54 after ten to fifteen puffs have been taken by a user. Puff counting can be performed in a variety of different ways. In some embodiments, the controller 40 determines when a temperature decreases during a puff, as fresh, cool air flows past the temperature sensor (not shown), causing cooling which is detected by the temperature sensor. In other embodiments, air flow is detected directly using a flow detector. Other suitable methods will be apparent to one of ordinary skill in the art. In other embodiments, the controller 40 additionally or alternatively interrupts the supply of electrical current to the induction coil 54 after a predetermined amount of time has elapsed since a first puff. This can help to both reduce power consumption and provide a back-up for switching off the aerosol generating device 30, 130 in the event that the puff counter fails to correctly register that a predetermined number of puffs has been taken.

In some examples, the controller 40 is configured to supply an alternating electrical current to the induction coil 54 so that it follows a predetermined heating cycle, which takes a predetermined amount of time to complete. Once the cycle is complete, the controller 40 interrupts the supply of electrical current to the induction coil 54. In some cases, this cycle may make use of a feedback loop between the controller 40 and a temperature sensor (not shown). For example, the heating cycle may be parameterised by a series of temperatures to which the inductively heatable susceptor 16 (or, more specifically the temperature sensor) is heated or allowed to cool. The temperatures and durations of such a heating cycle can be empirically determined to optimise the temperature of the aerosol generating liquid. This may be necessary as direct measurement of the temperature of the aerosol generating liquid can be impractical, or misleading.

The power source 38 is sufficient to at least bring the aerosol generating liquid in a single aerosol generating article 10, 110 up to the first temperature and maintain it at the first temperature to provide sufficient vapour or aerosol for at least ten to fifteen puffs. More generally, in line with emulating the experience of cigarette smoking, the power source 38 is usually sufficient to repeat this cycle (bring the aerosol generating liquid up to the first temperature, maintain the first temperature and vapour generation for ten to fifteen puffs) ten times, or even twenty times, thereby emulating a user's experience of smoking a packet of cigarettes, before there is a need to replace or recharge the power source 38.

Although exemplary embodiments have been described in the preceding paragraphs, it should be understood that various modifications may be made to those embodiments without departing from the scope of the appended claims. Thus, the breadth and scope of the claims should not be limited to the above-described exemplary embodiments.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

1. An aerosol generating article for use with an aerosol generating device having a heating chamber, the aerosol generating article comprising:
a porous liquid storage material for storing an aerosol generating liquid and configured for insertion into the heating chamber; and
an inductively heatable susceptor arranged in thermal proximity to the porous liquid storage material for heating and vaporising the stored aerosol generating liquid,
wherein the porous liquid storage material has a substantially annular shape and defines a centrally positioned opening.

2. The aerosol generating article according to claim 1, wherein the porous liquid storage material comprises a self-supporting material.

3. The aerosol generating article according to claim 1, wherein the porous liquid storage material comprises a high retention material.

4. The aerosol generating article according to claim 1, wherein the inductively heatable susceptor extends around the porous liquid storage material.

5. The aerosol generating article according to claim 1, wherein the inductively heatable susceptor is in thermal contact with a surface of the porous liquid storage material.

6. The aerosol generating article according to claim 1, wherein the inductively heatable susceptor is in thermal contact with a radially outer surface of the porous liquid storage material or with a radially inner surface of the porous liquid storage material.

7. An aerosol generating system, comprising:
an aerosol generating device comprising a heating chamber; and
an aerosol generating article according to claim 1 positioned in the heating chamber,
the aerosol generating device further comprising an induction heating arrangement for generating an alternating electromagnetic field for penetrating the inductively heatable susceptor to thereby inductively heat the inductively heatable susceptor.

8. The aerosol generating system according to claim 7, wherein the aerosol generating system includes a positioning arrangement to position the aerosol generating article in the heating chamber so that a longitudinal axis of the aerosol generating article is aligned with a longitudinal axis of the heating chamber.

9. The aerosol generating system according to claim 8, wherein the positioning arrangement comprises a projecting element that projects into the heating chamber and into the centrally positioned opening in the porous liquid storage material.

10. The aerosol generating system according to claim 9, wherein the projecting element comprises a non-inductively heatable material.

11. The aerosol generating system according to claim 9, wherein the induction heating arrangement comprises an induction coil.

12. The aerosol generating system according to claim 11, wherein the induction coil extends around the heating chamber.

13. The aerosol generating system according to claim 12, wherein the induction coil extends around an outer wall of the heating chamber and is positioned radially outwardly of the inductively heatable susceptor.

14. The aerosol generating system according to claim 11, wherein the induction coil extends around the projecting element and is positioned radially inwardly of the inductively heatable susceptor.

15. A method of using an aerosol generating system according claim 7 to generate an inhalable aerosol, the method comprising:
penetrating the inductively heatable susceptor with an alternating electromagnetic field generated by the induction heating arrangement to inductively heat the susceptor and thereby heat and vaporise the aerosol generating liquid stored in the porous liquid storage material.

16. The aerosol generating article according to claim 3, wherein the high retention material comprises a porous ceramic material.
